(19) United States
(12) Patent Application Publication
(10) Pub. No.: US 2004/0090876 A1
(43) Pub. Date: May 13, 2004

(54) Method of gathering track information during disc initialization

(75) Inventor: Yuan-Ting Wu, Hsin-Chu City (TW)

Correspondence Address: TROXELL LAW OFFICE PLLC, SUITE 1404, 5205 LEESBURG PIKE, FALLS CHURCH, VA, 22041, US

(73) Assignee: MediaTek Inc.

(21) Appl. No.: 10/649,878

(22) Filed: Aug. 28, 2003

(30) Foreign Application Priority Data
Nov. 8, 2002 (TW) 091132974

(51) Int. Cl. G11B 7/085

(52) U.S. Cl. 369/30.04

(57) ABSTRACT

The invention is a method for reading special track-related information on an optical storage medium. The medium sequentially has at least one session. Each session comprises a lead-in area and at least one track, wherein at least one session comprising one or more data tracks. A pickup head is firstly moved to read special track-related information in a target session. When reading the target session, first read Table of Content data of the lead-in area in the target session, and then sequentially read the data tracks in the target session for reading special track-related information. Only when finishing reading all data tracks in the target session, then the pickup head is moved to the next session for continuing reading the special track-related information.

### BACKGROUND OF THE INVENTION

1. Field of the Invention

The present invention relates to a method for reading special track-related information, and more particularly to a method for reading special track-related information on an optical storage medium.

2. Description of the Prior Art

A conventional optical storage medium has one or more sequential sessions. Each session comprises a lead-in area and at least one track. The track types comprise data track, and non-data track such as audio track. The data track contains user information and information of data track relating to Data Mode/Form, Packet Type (including Fixed Type and Variable Type), Packet Size, and Next Writable Address (NWA), known as special track-related information. The audio track does not contain such information.

When an optical storage medium is placed into an optical storage device for initialization, the optical storage device reads Table of Content (TOC) data of each lead-in area on the optical storage medium. The purpose of such reading is to acknowledge data distribution of the optical storage medium and record TOC data into system memories of the optical storage device. When the host needs to read TOC data, the pickup head of the optical storage device does not have to read from the optical storage medium but directly reads TOC data from the memories.

According to the prior art, there are several methods for the host to read the special track-related information of specific data tracks. One prior method is that the optical pickup head seeks the specific data tracks and reads. This method results in the pickup head moving unexpectedly to different specific data tracks back and forth for reading special track-related information.

Another prior method for the host to read the special track-related information of the specific data tracks is that the pickup head first long-seeks to each of the lead-in areas on the optical storage medium to read TOC data, and then sequentially short-seeks to each of the data tracks in each of the sessions to acquire special track-related information from the data tracks to record the special track-related information into the memories. Then, the host can directly read the memories in order to prevent the pickup head from seeking specific data tracks.

Although the host can directly read the memories for the special track-related information of the specific data tracks to reduce some seeking time for the pickup head. However, it needs extra time for the pickup head to read special track-related information of each of the data tracks and for recording those information into the memories. Therefore, such way of initialization is very time-consuming.

### SUMMARY OF THE INVENTION

An objective of the present invention is to provide a method for reading special track-related information on an optical storage medium, so as to reduce the time needed for initialization of the optical storage device.

According to a preferred embodiment of the present invention, in the method for reading special track-related information, first a pickup head is moved to read special track-related information in a target session on an optical storage medium. When reading the target session, first read TOC data of the lead-in area in the target session, and then sequentially read the data tracks in the target session for reading the special track-related information and record the information in system memories of the optical storage device. When finishing reading all of the data tracks in the target session, then the pickup head is moved to the next session for continuing on reading special track-related information.

In the method for reading special track-related information on the optical storage medium according to the present invention, the pickup head can continuously read TOC data of the lead-in area and special track-related information of each data track in a session. The pickup head does not need to move back and forth to read data. Therefore, the time needed for initialization can be decreased substantially.

The advantages and the spirits of the present invention will be understood further after reading the following detailed description of the preferred embodiment and the illustrated figures and drawings.

### BRIEF DESCRIPTION OF THE DRAWINGS

FIG. 1 is a schematic diagram of some part of an optical storage device and an optical storage medium according to the present invention.

FIG. 2 is a schematic diagram of the method for reading data on the optical storage medium shown in FIG. 1.

### DETAILED DESCRIPTION OF THE PREFERED EMBODIMENT

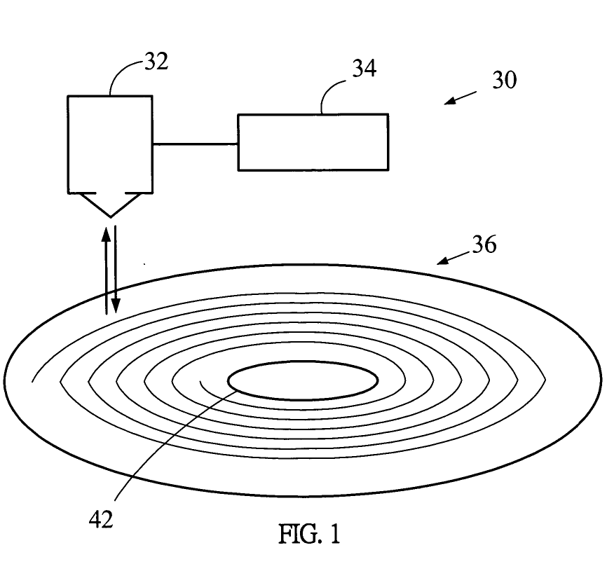

Referring to FIG. 1, FIG. 1 is a schematic diagram of some part of an optical storage device 30 and an optical storage medium 36 according to the present invention. The optical storage device 30 is used for reading data on the optical storage medium 36. The optical storage medium 36 has a program memory area (PMA) 42. The optical storage device 30 comprises a pickup head 32 and a controller 34. The pickup head 32 is used for reading data on the optical storage medium 36. The controller 34 is used for controlling and moving the pickup head 32 for reading data.

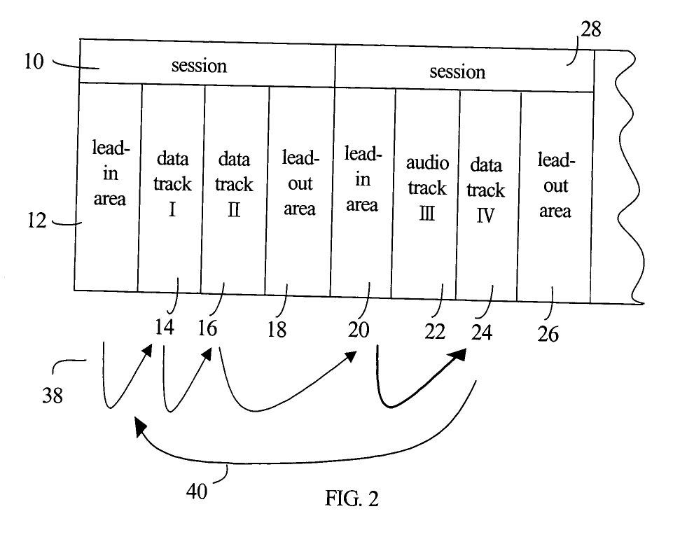

Referring to FIG. 2, FIG. 2 is a schematic diagram of the method for reading data on the optical storage medium 36 shown in FIG. 1. In an embodiment, the optical storage medium 36 has a plurality of sessions 10, 28, which are sequentially and un-repeatedly coded with corresponding serial numbers. The session 10 and the session 28 are respectively coded with serial numbers, which are 1 and 2, respectively, in this embodiment. Followings are detailed descriptions for a session, using the session 10 as an example. In this embodiment, the session 10 comprises a lead-in area 12, several tracks 14, 16, and a lead-out area 18 after the end of the data tracks. The lead-in area 12 records TOC data. The TOC data comprises the serial number of the session 10, the number of tracks in the session 10, the serial number and the type for each of the tracks in the session 10, and the corresponding starting addresses of all tracks in the session 10.

The track types comprise data track, and non-data track such as audio track. In the embodiment in FIG. 2, the tracks 14 and 16 in the session 10 are data tracks. Each of the data tracks 14, 16 comprises special track-related information. The special track-related information comprises information of the data track relating to Data Mode/Form, Packet Type (including Fixed Packet Type and variable Packet Type), Packet Size, and Next Writable Address (NWA). The non-data track does not have such information. Either data track or non-data track has a corresponding serial number. The serial numbers are sequentially and un-repeatedly coded within a session and across different sessions. In FIG. 2, the tracks 14 and 16 in the session 10 and the tracks 22 and 24 in the session 28 are sequentially coded as I, II, III, and IV.

As shown in FIG. 2, the optical storage medium 36 has the session 10 and the session 28 in sequential, and each of the sessions 10, 28 is coded with a corresponding serial number. The session 10 comprises a lead-in area 12, a data track I 14, a data track II 16 and a lead-out area 18. The session 28 comprises a lead-in area 20, an audio track III 22, a data track IV 24 and a lead-out area 26.

When the optical storage medium 36 is placed into the optical storage device 30, the optical storage device 30 performs the method of the present invention to execute initialization for the optical storage medium 36 to acknowledge data distribution of the optical storage medium 36. The controller 34 controls and moves the pickup head 32 to read the special track-related information of a target session. The target session in this case is the session 10, the first session on the optical storage medium 36.

As shown in FIG. 2, according to the method of the present invention, the pickup head 32 first moves to read special track-related information in the session 10. When reading the session 10, the pickup head 32 first reads TOC data of the lead-in area 12, and then sequentially reads special track-related information of the data track I 14 and the data track II 16. Only when finishing reading all of the data tracks in the target session, the session 10, the pickup head 32 skips the lead-out area 18 in the session 10 and continues on reading TOC data of the lead-in area 20 in the next session, the session 28.

The audio track III 22 in the session 28 is a non-data track. Therefore, the pickup head 32 will not read the audio track III 22 by skipping the non-data track but continuing on reading the next data track, the data track IV 24. In the same way, after finishing reading all data tracks in the session 28, the pickup head 32 skips the lead-out area 26 in the session 28 but continue on to the session next to the session 28. If there is no next session, the pickup head 32 moves back to the starting place in the session 10. As shown in FIG. 2, each of continuous arrows 38 and their directions thereof shows that the pickup head 32 moves and reads the lead-in area 12 of the session 10 at first, and then gradually moves to the next session. When there is no next session, the pickup head 32 moves back to the starting place in the session 10, as the arrow 40 points out in FIG. 2.

The PMA 42 on the optical storage medium 36 is for recording information relating to serial numbers, starting addresses, ending addresses and data attributes of data tracks that have been recorded with data on the optical storage medium 36. The PMA 42 is read when the optical storage medium 36 is placed into the optical storage device 30, and further recorded in system memories of the optical storage device 30.

When the pickup head 32 reads a session that is found to be an un-closed session, the pickup head 32 does not read the lead-in area of the un-closed session, but reads the information recorded in the PMA 42 to perform further judgment. Then, once there is any data track found in the un-closed session, the pickup head 32 directly jumps to read each data track in the un-closed session in order to read the special track-related information.

In contrast to the prior art, in the method for reading special track-related information on the optical storage medium 36 according to the present invention, the pickup head 32 can continuously read TOC data of the lead-in area and special track-related information of each data track in a session. The pickup head 32 does not need to move back and forth to read data. Therefore, the time needed for initialization can be decreased substantially.

With the example and explanations above, the features and spirits of the invention will be hopefully well described. Those skilled in the art will readily observe that numerous modifications and alterations of the device may be made while retaining the teaching of the invention. On the contrary, the above disclosure should be construed as limited only by the metes and bounds of the appended claims.

What is claimed is:

1. A method of reading special track-related information on an optical storage medium, said optical storage medium having at least one session comprising a lead-in area and at least one data track, said method comprising:
moving a pickup head for reading special track-related information in a target session;
first reading TOC (Table of Content) data of said lead-in area in said target session, and then sequentially reading said data tracks in said target session for reading said special track-related information; and
only when finishing reading all of said data tracks in said target session, then moving said pickup head to the next session for continuing on reading special track-related information.

2. The method of claim 1, wherein said sessions are sequentially coded with corresponding serial numbers, and said target session is the first session on said optical storage medium.

3. The method of claim 1, wherein said pickup head sequentially reads said sessions, till all of the sessions on said optical storage medium are read.

4. The method of claim 1, wherein said pickup head is accommodated in an optical storage device, and when said optical storage medium is placed into said optical storage device, said optical storage device performs said method to execute initialization of said optical storage medium to acknowledge data distribution on said optical storage medium.

5. The method of claim 1, wherein when said pickup head reads TOC data of said lead-in area and finds a non-data track, said pickup head skips reading in the non-data track, and continues on to the next data track.

6. The method of claim 5, wherein said non-data track is an audio track.

7. The method of claim 1, wherein said special track-related information comprises information of data tracks relating to Data Mode/Form, Packet Type including Fixed Packet Type and Variable Packet Type, Packet Size, and Next Writable Address (NWA).

8. The method of claim 1, wherein said optical storage medium further comprises a Program Memory Area (PMA) for recording information relating to serial numbers, starting addresses, ending addresses and attributes of tracks which have been recorded on said optical storage medium.

9. The method of claim 8, wherein when said pickup head reads said session which is found to be an un-closed session, said pickup head does not read said lead-in area of said un-closed session, but reads information recorded in the PMA to perform further judgment, and wherein when any data track is found in said un-closed session, said pickup head jumps directly to said un-closed session to sequentially read said data tracks for reading said special track-related information.

10. The method of claim 9, wherein the PMA of said optical storage medium is read when said optical storage medium is placed into said optical storage device, and further recorded in system memories of said optical storage device.

11. A optical device for reading special track-related information on an optical storage medium, said optical storage medium having at least one session comprising a lead-in area and at least one data track, said optical device comprising:
a pickup head, for reading special track-related information on said optical storage medium; and
a controller, for controlling and moving said pickup head for reading said special track-related information in a target session;
wherein when reading in said target session, said pickup head first reads TOC (Table of Content) data of said lead-in area in said target session, and then sequentially reads said data tracks in said target session for reading said special track-related information; and wherein only when finishing reading all of said data tracks in said target session, said pickup head is then moved to the next session for continuing on reading special track-related information.

12. The optical device of claim 11, wherein said sessions are sequentially coded with corresponding serial numbers, and said target session is the first session on said optical storage device.

13. The optical device of claim 11, wherein said pickup head sequentially reads said session, till all of the sessions on said optical storage medium are read.

14. The optical device of claim 11, wherein when said optical storage medium is placed into said optical storage device, said optical storage device will perform initialization of said optical storage medium to acknowledge data distribution on said optical storage medium.

15. The optical device of claim 11, wherein when said pickup head reads TOC data of said lead-in area and finds a non-data track, said pickup skips reading in the non-data track, and continues for reading the next data track.

16. The optical device of claim 15, wherein said non-data track is an audio track.

17. The optical device of claim 11, wherein said special track-related information comprises information of data tracks relating to Data Mode/Form, Packet Type including Fixed Packet Type and variable Packet Type, Packet Size, and Next Writable Address (NWA).

18. The optical device of claim 11, wherein said optical storage medium further comprise a PMA for recording information relating to serial numbers, starting addresses, ending addresses and attributes of tracks which have been recorded in said optical medium.

19. The optical device of claim 18, wherein when said pickup head reads said session which is found to be an un-closed session, said pickup head does not read said lead-in area of said un-closed session, but reads information recorded in the PMA to perform further judgment, and wherein when any data track is found in said un-closed session, said pickup head jumps directly to said un-closed session to sequentially read said data tracks for reading said special track-related information.

20. The optical device of claim 19, wherein said Program Memory Area (PMA) of said optical storage medium is read and recorded in system memories, when said optical storage medium is placed into said optical storage device.
